(19) United States
(12) Patent Application Publication
(10) Pub. No.: US 2007/0064433 A1
(43) Pub. Date: Mar. 22, 2007

(54) RECESSED LIGHT FIXTURE AND SPEAKER COMBINATION

(76) Inventor: Doug Wright, Simi Valley, CA (US)

Correspondence Address: LOZA & LOZA LLP, 6285 EAST SPRING STREET, # 327-N, LONG BEACH, CA, 90808, US

(21) Appl. No.: 11/424,855

(22) Filed: Jun. 17, 2006

Related U.S. Application Data
(60) Provisional application No. 60/691,378, filed on Jun. 17, 2005.

(51) Int. Cl. F21V 15/00

(52) U.S. Cl. 362/364

(57) ABSTRACT

At least one embodiment of the invention provides a recessed assembly combining a light fixture and a speaker assembly. The light fixture is a light source that is excited via an array of high-intensity light-emitting-diodes (LED) and is imbedded into a ceiling-mounted recessed assembly. The light fixture may be fashioned such that it closely mimics existing, commonly available recessed ceiling lighting assemblies. A speaker assembly is mounted within the recessed assembly so that both light and sound can be provided by the recessed assembly.

### CLAIM OF PRIORITY UNDER 35 U.S.C. §119

The present Application for Patent claims priority to Provisional Application No. 60/691,378 entitled “Recessed Light Fixture and Speaker Combination”, by Doug S. Wright, filed Jun. 17, 2005, and expressly incorporated by reference herein.

### FIELD

Various embodiments of the invention pertain to recessed lighting and audio fixtures. More particularly, at least one embodiment of the invention relates to a recessed light assembly having an integrated loudspeaker.

### DESCRIPTION OF RELATED ART

In order to save space, and/or for aesthetic reasons, it is often desirable to mount light fixtures and speakers within wall or ceiling cavities or recesses. This is typically done by mounting separate light and speaker fixtures. However, these separate mountings require more openings to be cut into a wall or ceiling, often detracting from the aesthetics of the room or environment in which they are mounted.

### SUMMARY

A recessed assembly is provided comprising: (a) a recessed frame, (b) a light fixture mounted in the recessed frame, and (c) a first speaker mounted in the recessed frame. The first speaker may be mounted substantially concentric with the light fixture. A second speaker may be mounted in the recessed frame, wherein the second speaker is substantially concentric with the light fixture. The light fixture may include a plurality of light-emitting-diodes (LEDs) mounted concentrically on an annular frame that defines an opening through which the first speaker is mounted. An extendible post may be coupled to the recessed frame at one end and coupled to the first speaker at the other end, the extendible post permitting mounting the first speaker at different heights relative to the recessed assembly. An IP networking interface may permit uniquely addressing the recessed assembly and independently control the light fixture and the first speaker. The light fixture and first speaker may be coupled together and mounted substantially central to the recessed assembly. The light fixture includes a light source capable of providing sufficient light to illuminate a particular area. Additionally, a baffle may be mounted along the circumference of the recessed assembly, wherein the light fixture is mounted on the baffle.

Another embodiment provides a light and speaker device, comprising: (a) an illumination device capable of providing sufficient light to adequately illuminate a particular area, and (b) a first speaker coupled to the illumination device, wherein the illumination device is mounted concentric with the first speaker. The light fixture includes a plurality of light-emitting-diodes (LEDs). The LEDs are mounted concentrically on an annular frame that defines an opening through which the first speaker is mounted. In various embodiments, the light fixture may also include a fluorescent light source and a fiber optic light source.

### BRIEF DESCRIPTION OF THE DRAWINGS

FIG. 1 illustrates a cross-sectional view of a recessed assembly having a light fixture and audio device combination according to one embodiment of the invention.

FIG. 2 illustrates a front view of the recessed assembly of FIG. 1 according to one embodiment of the invention.

FIG. 3 illustrates a side view of the recessed assembly of FIG. 1 according to one embodiment of the invention.

FIG. 4 illustrates a rear view of the recessed assembly of FIG. 1 according to one embodiment of the invention.

FIG. 5 illustrates another light fixture that may be used in one embodiment of the invention.

### DETAILED DESCRIPTION

In the following description numerous specific details are set forth in order to provide a thorough understanding of the invention. However, one skilled in the art would recognize that the invention may be practiced without these specific details. In other instances, well known methods, procedures, and/or components have not been described in detail so as not to unnecessarily obscure aspects of the invention.

The following description, certain terminology is used to describe certain features of one or more embodiments of the invention. The term “audio device” refers to any type of sound-generating device, including a speaker, loudspeaker, audio speaker, woofer, subwoofer, tweeter, and/or acoustic transducer. The term “light fixture” refers to any type of light-generating device, including a fluorescent light, incandescent light, light-emitting diode light source, fiber optic light source, etc.

One aspect of the invention provides a recessed mounting assembly that permits housing both a light fixture and speaker and in a single enclosure. Such combination of light and speaker systems is highly coveted since it minimizes the number and variation of fixtures mounted on/in a ceiling. That is, rather than installing separate light and speaker housings, a single enclosure is used to house both a light fixture and speaker.

Combining a light and speaker in the same fixture has several challenges. First, speakers typically include components that are susceptible to the heat generated by conventional incandescent light bulbs. Secondly, in order to obtain a reasonable sound quality, the sound propagating from the speaker should not be impaired by the light fixture. Thirdly, the life of conventional light bulbs may be shortened by the normal vibration of speakers during operation.

One embodiment of the present invention combines the functions of a light fixture and a speaker into a single recessed assembly 110. The light fixture 100 may be an illuminator or light source that is excited via an array of high-intensity light-emitting-diodes (LED) 101 and is imbedded into a ceiling-mounted assembly 110. The light fixture 100 may be fashioned such that it closely mimics existing, commonly available recessed ceiling lighting assemblies. By replacing the typically used incandescent light source and its accompanying high heat with the much cooler running and physically smaller LEDs 101 it becomes possible to integrate a high performance loudspeaker system into a light assembly 110.

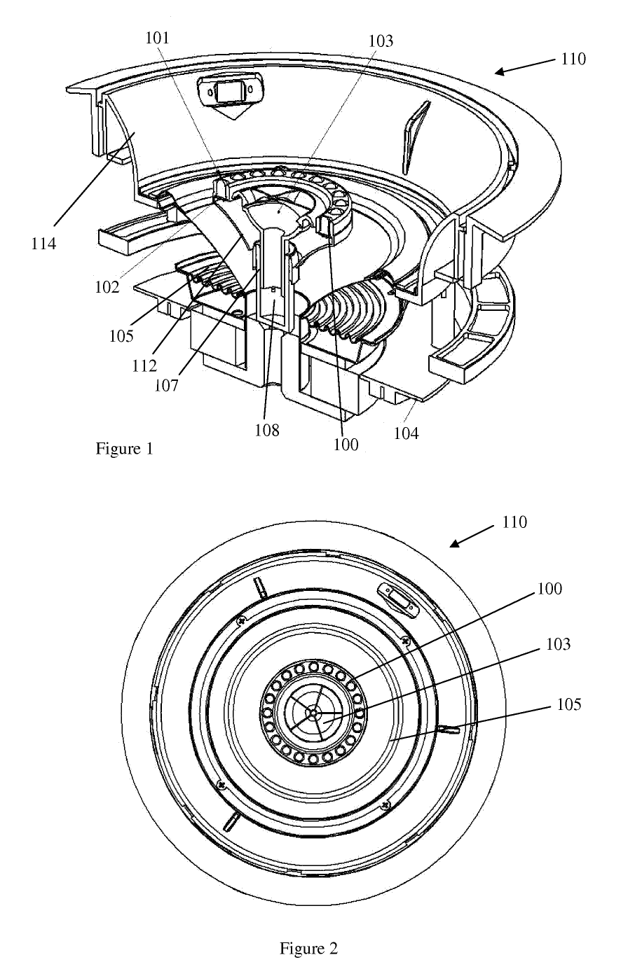

FIG. 1 illustrates a cross-sectional view of a recessed assembly 110 having a light fixture/source 100 and audio device 103 combination according to one embodiment of the invention. The light fixture 100 is a circular array of LEDs 101 mounted on a frame. The LEDs 101 are electrically affixed onto a circular printed circuit board (PCB) 102 and placed annularly to form the light source 100. The circular array of LEDs 101 may define a center opening through which a first audio device (e.g., tweeter) 103 may be mounted. The LEDs 101 may be mounted perpendicular to the plane that is defined by the first audio device's 103 sound-radiating surface. In this manner, the light emitted by the LEDs 101 radiates outward from the recessed assembly 110 and toward an intended location to be illuminated. In one embodiment of the invention, the light fixture 100 may be permanently or removably coupled to the first audio device 103. For example, the light fixture 100 may be integral with the first audio device 103 or it may be removable from the first audio device 103.

The LEDs 101 may be sufficient in number and/or of sufficient intensity to generate a light source of a desired intensity. In one embodiment of the invention the light fixture 100 may come in different configurations to provide low, medium, or high light intensity. In yet another embodiment, a light fixture 100 may have two or more settings that permit generating two or more levels of light intensity. A switch electrically coupled to the light fixture 100 may allow a user to set the desired light intensity. Such light intensity may be regulated by controlling the voltage to one or more of the LEDs 101 or by selectively turning some LEDs On while others remain Off. Thus, different light intensities may be achieved with the light fixture 100.

Another embodiment of the invention provides for mounting LEDs on other surfaces or areas of the recessed assembly. For example, a plurality of LEDs may be mounded on the outer perimeter of the baffle 114 or on the interior walls of the baffle 114.

The first audio device 103 is mounted on a telescoping post 107 that is extendable or retractable to set the light fixture 100 or first audio device 103 at a desired level. The telescoping post 107 may provide an inner passage 108 through which electrical wires to the light fixture 100 and/or first audio device 103 are routed. Thus, the light fixture 100 can be securely mounted to the frame assembly and will not move or vibrate substantially even when the first or second audio devices 103 and 105 are generating sounds.

Another feature of the invention provides a ball-and-socket mount (not visible in figures) on the telescoping post 107 that permits angling the light fixture 100 and/or first audio device 103 in a desired direction. The ball-and-socket mount may be adjustable to direct the light and/or sound as desired.

A second audio device 105 (e.g., woofer, etc.) may be mounted within the recessed assembly 110 to provide a different frequency range than the first audio device 103. The second audio device 105 may be mounted using a secondary frame 104 concentric with the light fixture 100 with the extendable post 107 extending through the center of the second audio device 105. By mounting the first audio device 103 and light fixture 100 near the center of the recessed assembly 110 and keeping their diameter smaller than the diameter of the second audio device 105 this permits sounds from the second audio device 105 to propagate relatively unobstructed. This may also be accomplished by mounting the light source on the perimeter of the audio device 103.

To further improve the sound dispersion from the second audio device 105, the light fixture 100 may include a conical baffle 112 that minimizes sound wave reflections off the backside of the light source 100. Instead, this conical baffle 112 allows sound waves from the second audio device to bend around the first audio device 103 and light fixture 100.

The recessed assembly 110 may also include onboard electronics drive unit and/or power conversion unit for the lighting system and/or speaker amplifier system that drives the first and/or second audio devices 103 and 105. The electronics drive unit and/or power conversion unit may be mounted on a PCB coupled to the rear of the recessed assembly 110 and run at a reduced voltage to improve safety and reduce overall power consumption.

Another feature of the invention provides one or more input interfaces on the recessed assembly. For example, the assembly 110 can optionally feature inputs such as speaker-level audio signals to the one or more audio devices 103 and 105, and/or light control inputs to set the level of light intensity, etc.

In one implementation, a power transformer is provided on the recessed assembly 110 for public address applications (e.g., 75 volt power source). Another feature provides a local amplifier on the recessed assembly that enables low-level signals to power or drive the speaker(s) 103 and/or 105.

Yet another feature of the invention provides a built-in, wired or wireless IP based network interface (e.g., compliant with IEEE 802.11 standards, etc.). For example, the recessed assembly 110 may have one or more IP addresses associated with it so that the light fixture and/or speakers can be individually controlled. Such data or control interface may enable wired or wireless operation of the light fixture 100 and/or audio devices 103 and 105. For instance, a control system may control light intensity, speaker volume, etc. for each recessed assembly independently.

In yet another feature, the invention provides a circuit that, in one mode of operation, causes the light fixture to flash in conjunction with the lights. This circuit may synchronize the lights to the sound emitted by the speaker assembly. Alternatively, the circuit may receive a signal from smoke detectors and cause the lights to blink, flash, or turn On to alert the hearing-impaired of the smoke alarm.

In another embodiment of the invention, the light source may be a plurality of fiber optic strands that are positioned on the light fixture 100 to provide light. The fiber optic strands may be routed through the passage 108 in the extension post 107 to a unit that provides light to the fiber optic strands.

Another feature of the invention provides a light source that can selectably or randomly emit different colors of light. For instance, multi-colored LEDs may be employed that can be set (e.g., by voltage or current) to provide a given colors of light. In this manner, the light source can radiate one or more colors, either one color at a time or a plurality of colors at once. Similarly, when the light source includes fiber optic strands, different colors can be created by a unit that provides different colors of light to the fiber optic strands.

FIG. 2 illustrates a front view of the recessed assembly 110 of FIG. 1 according to one embodiment of the invention. As can be observed, the light fixture 100 is mounted substantially at the center of the recessed assembly 110 consistent with the traditional look of conventional recessed lights.

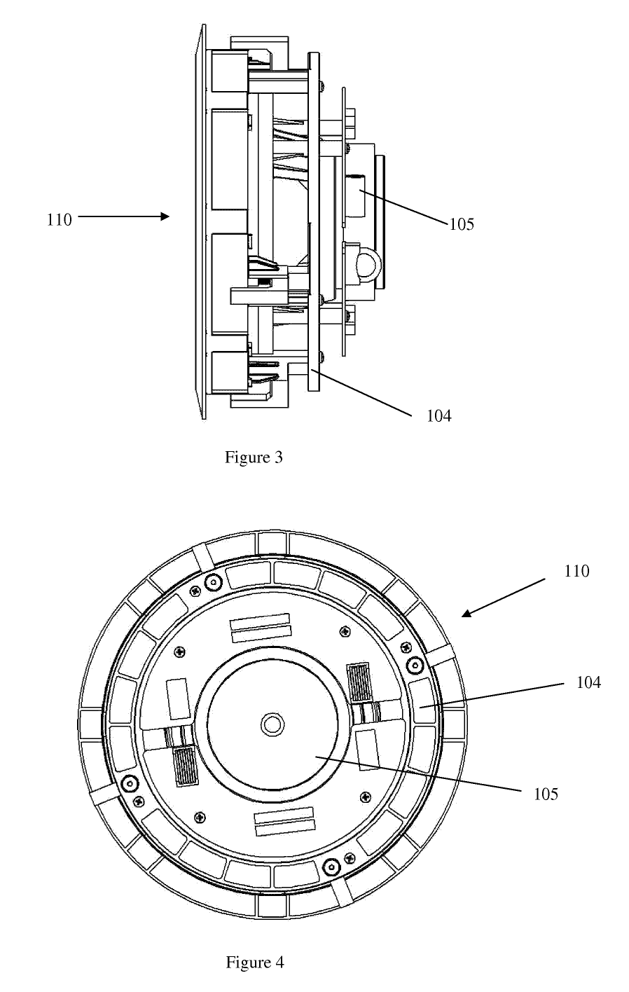

FIG. 3 illustrates a side view of the recessed assembly 110 of FIG. 1 according to one embodiment of the invention.

FIG. 4 illustrates a rear view of the recessed assembly 110 of FIG. 1 according to one embodiment of the invention.

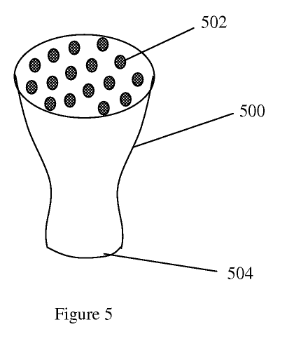

FIG. 5 illustrates another light fixture 500 that may be used in one embodiment of the invention. The light fixture 500 includes a plurality of light-emitting devices 502 (e.g., LEDs or fiber optic strands) covering the majority of the face of the light fixture 500. This implementation may increase the amount of light that is provided. The light fixture 500 may replace the first audio device 103 and light fixture 100 combination in the recessed assembly 110. That is, a coupling end 504 of the light fixture 500 may be mounted at the same location as the extendable post 107 and coupled to the recessed assembly. The second audio device 105 is still part of the recessed assembly. One implementation provides the light fixture 500 mounted on an extendable post so that its position relative to the second audio device 105 can be adjusted. In one example, the recessed assembly 110 may be configured to receive either the light fixture 500 or the light fixture 100 and first audio device 103 combination. Thus, an installer can interchange these components as desired during installation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A recessed assembly comprising:
a recessed frame;
a light fixture mounted in the recessed frame; and
a first speaker mounted in the recessed frame.

2. The recessed assembly of claim 1 wherein the first speaker is mounted substantially concentric with the light fixture.

3. The recessed assembly of claim 1 further comprising:
a second speaker mounted in the recessed frame, wherein the second speaker is substantially concentric with the light fixture.

4. The recessed assembly of claim 3 further comprising:
an electronic device for controlling operation of the light fixture and the first and second speakers.

5. The recessed assembly of claim 1 wherein the light fixture includes a plurality of light-emitting-diodes (LEDs).

6. The recessed assembly of claim 5 wherein the LEDs are mounted concentrically on an annular frame that defines an opening through which the first speaker is mounted.

7. The recessed assembly of claim 1 wherein the light fixture includes a fiber optic light source.

8. The recessed assembly of claim 1 further comprising:
an extendible post coupled to the recessed frame at one end and coupled to the first speaker at the other end, the extendible post permitting mounting the first speaker at different heights relative to the recessed assembly.

9. The recessed assembly of claim 1 further comprising:
an IP networking interface that permits uniquely addressing the recessed assembly.

10. The recessed assembly of claim 9 wherein the IP networking interface enables independent control of the light fixture and the first speaker.

11. The recessed assembly of claim 1 wherein the light fixture and first speaker are coupled together and mounted substantially central to the recessed assembly.

12. The recessed assembly of claim 1 wherein the light fixture includes a light source capable of providing sufficient light to illuminate a particular living area.

13. The recessed assembly of claim 1 further comprising:
a baffle mounted along the circumference of the recessed assembly, wherein the light fixture is mounted on the baffle.

14. A recessed assembly comprising
housing means for securing the recessed assembly within a recessed space;
illumination means for illuminating a particular area; and
sound-generating means for generating sounds.

15. The recessed assembly of claim 14 further comprising:
means for adjusting the intensity of the illumination means independently from the sound-generating means.

16. A light and speaker device, comprising:
an illumination device capable of providing sufficient light to adequately illuminate a particular area; and
a first speaker coupled to the illumination device, wherein the illumination device is mounted concentric with the first speaker.

17. The light and speaker device of claim 16 wherein the light fixture includes a plurality of light-emitting-diodes (LEDs).

18. The light and speaker device of claim 17 wherein the LEDs are mounted concentrically on an annular frame that defines an opening through which the first speaker is mounted.

19. The light and speaker device of claim 16 wherein the light fixture includes a fluorescent light source.

20. The light and speaker device of claim 16 wherein the light fixture includes a fiber optic light source.
